(19) United States
(12) Patent Application Publication
(10) Pub. No.: US 2020/0000258 A1
(43) Pub. Date: Jan. 2, 2020

(54) MEHTHOD OF MONITORING AN EATING UTENSIL AND SMART EATING UTENSIL

(71) Applicant: KONINKLIJKE PHILIPS N.V., EINDHOVEN (NL)

(72) Inventors: AJITKUMAR ADYAPRASAD DUBEY, BANGALORE (IN); KAPIL MANCHANDA, BANGALORE (IN); RAJENDRA SINGH SISODIA, BHOPAL (M.P) (IN)

(21) Appl. No.: 16/467,512

(22) PCT Filed: Dec. 7, 2017
(86) PCT No.: PCT/EP2017/081872

§ 371 Date: Jun. 7, 2019

(30) Foreign Application Priority Data
Dec. 9, 2016 (EP) 16203071.2

(51) Int. Cl. A47G 21/02; G09B 19/24

(52) U.S. Cl. CPC A47G 21/02; A47G 21/04; A47G 21/023; G09B 19/24

(57) ABSTRACT

An eating utensil (100) is provided which comprises a handle (120) and a food area (110). The eating utensil (100) comprises an accelerometer sensor a gyroscope sensor (150). With the accelerometer sensor the gyroscope sensor (150), the movement of the eating utensil (100) as well as its orientation is detected. The orientation as well as a movement of the eating utensil (100) can be compared with a predetermined ideal traversal path and orientation of an eating utensil (100) and the user may receive corresponding feedback if the detected path or orientation of the eating utensil (100) differs from the ideal utensil traversal path or orientation.

### FIELD OF THE INVENTION

The present invention relates to a method of monitoring an eating utensil as well as to an eating utensil.

### BACKGROUND OF THE INVENTION

Learning to eat with an eating utensil such as a spoon or a fork can be very difficult for a child. Parents around the world struggle to feed their children correctly and to teach them proper eating habits. It can be in particularly difficult for a child to learn how to hold a spoon or fork and how to move the eating utensil such that the food on the eating utensil reaches the mouth.

CN 104622207 discloses a spoon which comprises a head, a temperature sensor and an acceleration sensor. Furthermore, a Bluetooth or WiFi transmitter is provided.

### SUMMARY OF THE INVENTION

It is an object of the invention to provide an eating utensil that can help the user to learn to eat with the eating utensil.

According to an aspect of the invention, an eating utensil is provided which comprises a handle and a food area. The eating utensil comprises an accelerometer sensor and a gyroscope sensor. With the accelerometer sensor and the gyroscope sensor, the movement of the eating utensil as well as its orientation is detected. The orientation as well as a movement of the eating utensil can be compared with a predetermined ideal traversal path and orientation of an eating utensil and the user may receive corresponding feedback if the detected path or orientation of the eating utensil differs from the ideal utensil traversal path or orientation.

According to an aspect of the invention, a temperature of food in the food area is detected by a temperature sensor. A weight of food in the food area is detected by a weight sensor. The temperature data and the weight data are forwarded by a wireless communication unit to a smart device.

According to a further aspect of the invention, the position and orientation data from the accelerometer sensor and the gyroscope sensor are filtered based on the frequency thereof and static state points are removed. The coordinates are outputted wirelessly via the wireless communication unit to the smart device.

According to a further aspect of the invention, the detected orientation and path of the eating utensil is compared with a reference orientation and path. A correction indication is outputted if the detected orientation in the path of the eating utensil deviates from the reference orientation and reference path. A user can be notified if the temperature of the food on the food area is too high or too cold or if the weight of the food portion is not as per reference guideline.

According to a further aspect of the invention, a system of monitoring the eating utensil is provided. An eating utensil has a food area and a handle, an accelerometer sensor and a gyroscope sensor and a wireless communication unit to wirelessly transmit the detected accelerometer and gyroscope data to a smart device. A smart device is provided to wirelessly receive the transmitted accelerometer and gyroscope data from the smart utensil to compare the detected orientation in path of the eating utensil with a reference orientation in path and to output a corresponding indication if the detected orientation in path of the eating utensil deviates from the reference orientation and reference path.

It shall be understood that a preferred embodiment of the present invention can also be a combination of the dependent claims or above embodiments or aspects with respective independent claims.

These and other aspects of the invention will be apparent from and elucidated with reference to the embodiment(s) described hereinafter.

### BRIEF DESCRIPTION OF THE DRAWINGS

In the following drawings:

FIG. 1 shows a schematic representation of an eating utensil according to an aspect of the invention,

FIG. 2 shows a schematic representation of an eating utensil according to a further aspect of the invention,

FIG. 3 shows a schematic representation of part of an eating utensil according to a further aspect of the invention,

FIG. 4 shows a schematic flow chart indicating a processing in an eating utensil according to an aspect of the invention,

FIG. 5 shows a normal eating utensil transversal path, and

FIG. 6 shows a reference path of an eating utensil.

### DETAILED DESCRIPTION OF EMBODIMENTS

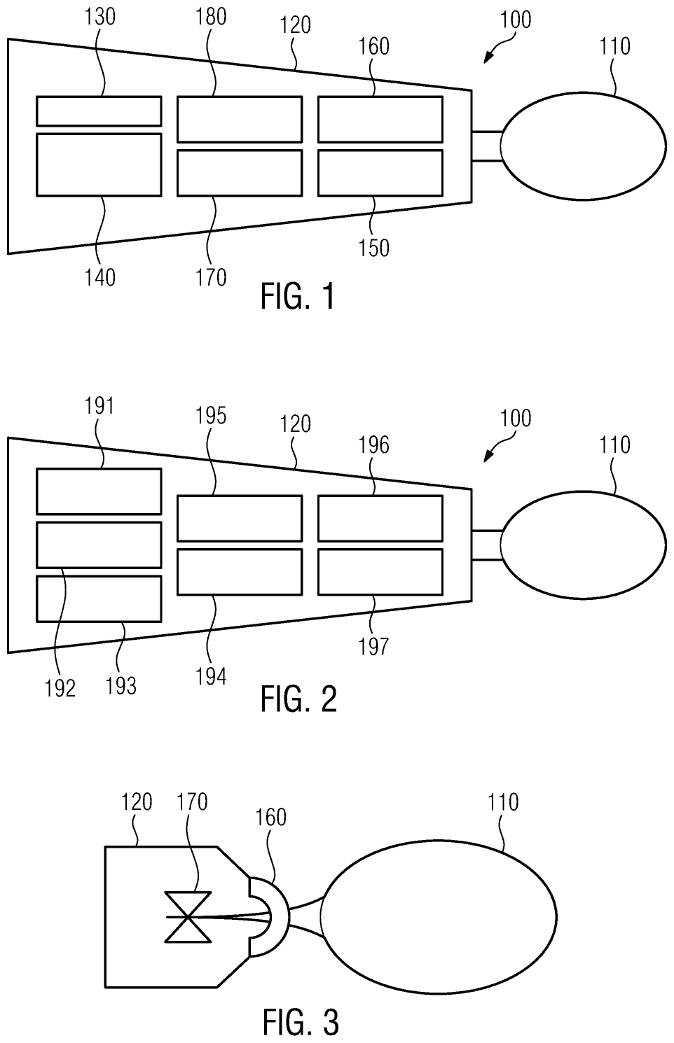

FIG. 1 shows a schematic representation of an eating utensil according to an aspect of the invention. The eating utensil 100 according to an aspect of the invention comprises a food area 110 which can be implemented as a fork or a spoon. Furthermore, the eating utensil comprises a handle 120, a battery 130, a processor 140, an accelerometer and/or gyroscope sensor 150, optionally a temperature sensor 160, optionally a weight sensor 170 and a wireless communication unit 180.

By means of the accelerometer sensor and/or the gyroscope sensor 150, the orientation as well as the movement and velocity of the eating utensil can be detected. The temperature sensor 160 can be used to detect the temperature of food on the fork or spoon 110. The weight sensor 170 can be used to determine the weight of food on the fork or spoon 110. As the eating utensil 100 is a smart utensil hardware it comprises a battery 130 for supplying electrical energy to the processor 140, the weight sensor 170, the temperature sensor 160, the accelerometer sensor and the gyroscope sensor 150 as well as to the wireless communication unit 180.

FIG. 2 shows a schematic representation of an eating utensil according to a further aspect of the invention. In FIG. 2, in particular the different processing algorithms that are required for the eating utensil 100 are depicted. A weight processing 194 is performed by a weight sensor 170 to determine the weight of food on the fork or spoon 110. This data can be forwarded to a cloud client processing 192. The temperature processing 197 uses the temperature data from the temperature sensor 160 to determine the temperature of food on the spoon 110. This temperature data can be processed by the cloud client processing 192.

A notification processing 193 is used to manage notifications for example by means of an LED to indicate a high or low temperature of the food and to indicate the start or finish of the meal. The coordinate filter processing 196 is used to filter coordinates of the data detected by the accelerometer sensor and the gyroscope sensor 150 based on frequency. Furthermore, static state points may be removed by the coordinate filter processing 196.

According to an aspect of the invention, a reference (ideal) guide path can be inputted. A system to enter such guidance to smart guide server 200 can be via a software module using a digital trace or drawing or via specific syntax. For e.g. guidelines for different age groups or based on type of food or diet can be added. E.g. for a 3 year old, how to feed him may require that after each bite a specific amount of time needs to be given, will guide a specific portion per bite and how to hold spoon/fork and eat. The tracking not only requires the trace of the path but also sampling of different sensor data. For example, to teach them not to spill while holding a spoon, required that weight of the content within the spoon holding unit is sample twice to determine spillage. Or to teach them to blow a hot food before eating required sampling temperature twice, to see variation on food temperature.

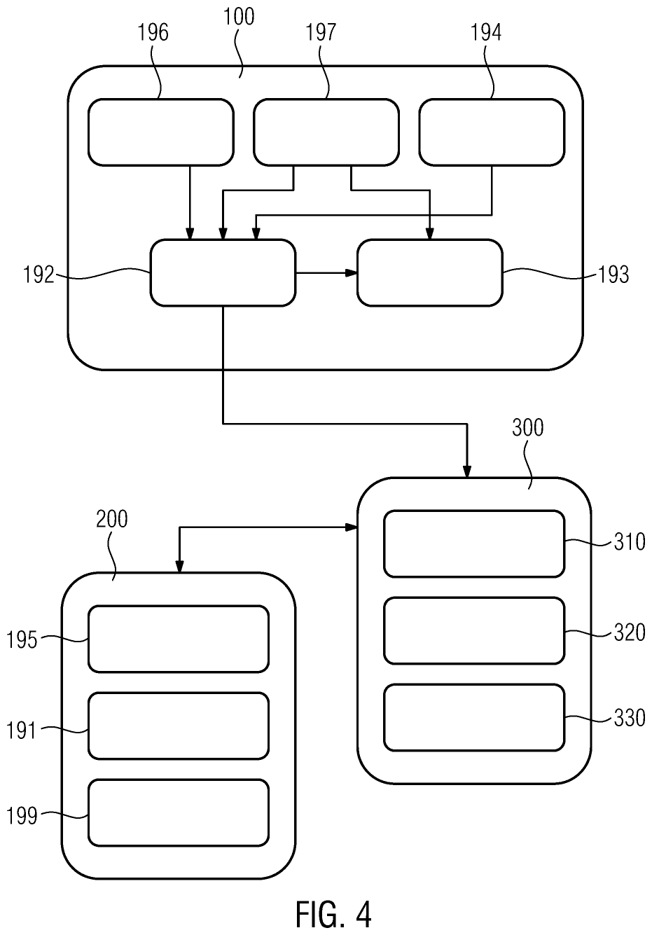

The cloud client processing 192 receives the weight data from the weight sensor 170 as well as the temperature data from the temperature sensor 160 as described in more detail in FIG. 4. The cloud client processing 192 then sends filtered motion coordinate data, temperature data, weight data etc. to an external device 300 (like a smartphone, tablet, etc.) via the wireless communication unit 180. The external device 300 sends filtered motion coordinate and user profile to smart guide server 200. In the smart guide server 200, in the sequential motion path processing 195, the path of the eating utility is determined based on the coordination data by the coordinate filter processing 196.

FIG. 3 shows a schematic representation of part of an eating utensil according to a further aspect of the invention. The eating utility 100 comprises a food area (a spoon or fork area) 110 as well as a handle 120. Furthermore, a weight sensor 170 and a temperature sensor 160 are provided. The weight sensor 170 can be attached to the spoon or fork area 110 to determine a weight of food on the spoon or fork area 110. The weight sensor 170 may use a pulley or balance concept to measure the weight of the food on the spoon or fork area 110. The temperature sensor 160 detects the temperature as measured by the same conduction material attached to the spoon/fork material and which is also attached to the sensor.

FIG. 4 shows a schematic flow chart indicating a processing in an eating utensil according to an aspect of the invention. According to an aspect of the invention, the eating utensil 100 can be coupled wirelessly to a smartphone or smart device 300. The smart device 300 may be coupled in turn to an external server 200. The communication between the server 200 and the smart device 300 may be via the internet and is at least partially performed wirelessly. The communication between the eating utensil and the smart device 300 is performed by a wireless communication in particular via the wireless communication unit 180.

As mentioned above with respect to FIG. 2, in the eating utility 100, several processing are performed. A coordinate filter processing 196 receives the data from the accelerometer and the gyroscope sensor 150 and forwards the coordinate data to the cloud client processing 192 which can for example be processed or be performed by the processor 140. In the temperature processing 197, the temperature data from the temperature sensor 160 is forwarded to the cloud client processing 192 as well as to a notification processing 193. In the weight processing 194, the weight data from the weight sensor 170 is forwarded to the cloud client processing 192. The notification processing 193 receives temperature data from the temperature processing 197 and can output an optical and/or acoustic alert. In particular, the notification processing 193 can indicate whether the food on the spoon or fork area 110 is too cold or too hot.

The cloud client processing 192 forwards the received coordination data, the temperature data and optionally the weight data in particular wirelessly via the wireless communication 180 to a smart device 300.

The smart device 300 may be implemented as a tablet, a smart phone, a smart TV, a computer or the like. In the smart device 300, a guide movement unit 310, a gamification processing unit 320 and a user registration 330 can be provided. The user registration 330 can be used to input a profile of a user such as age, location etc. The gamification unit 320 can be used to teach the user to learn eating correctly with the eating utensil. Optionally, the gamification unit can be used to create and display animated characters moving along on the guided path motion as means to teach a child how to eat.

In the guide movement unit 310 the actual movement of the eating utensil can be displayed with respect to an ideal movement.

In the server unit 200, a sequential motion, a processing 195 can be performed. Here, a user eating utensil movement path can be created based on the filter coordinate movement data. In the server unit 200, a sequential movement guide processing 191 can be performed by evaluating the user movement generated path with the recommended or ideal path. Furthermore, a guidance or recommendation for the spoon path can be provided. The recommendation or guidance can be both a pro-active or passive. In pro-active mode, the notification will be instantaneous for e.g. if the diversion happens as per reference plan (by vibrating the spoon) or passive to evaluate and provide feedback to the user or evaluator (for e.g. to mother/pediatricians).

Furthermore, the server unit 200 may comprise a health configuration processing 199 which may evaluate a best practice for using the eating utensil based on health standards and/or medical information. This can be used to teach the user, in particular a child, healthy eating in order to avoid obesity. Furthermore, this processing can be used to determine the number of meals, the time between the meals, the time between each bite to check whether chewing duration is as per reference.

The sequential motion processing 191 compares the path of the eating utensil as detected by the accelerometer sensor and the gyroscope sensor 150 with a reference path.

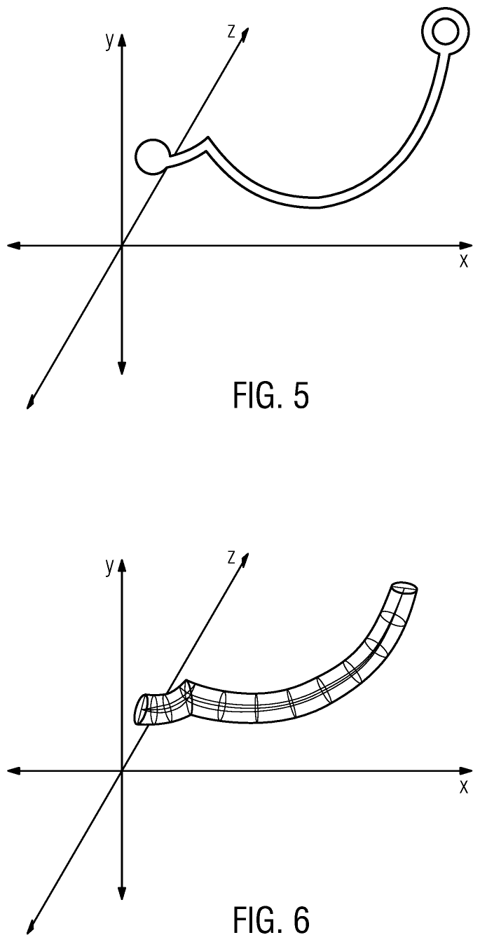

FIG. 5 shows a normal eating utensil transversal path. The accelerometer sensor and the gyroscope sensor 150 output accelerometer data and gyroscope data which can be used to create a 3D Cartesian space around the eating utensil 100. The Cartesian space has several points Psₙ (xₙ, yₙ, zₙ) at any given time tₙ. n can be a sample index. Furthermore, the relative velocity and/or acceleration of the eating utensil may be determined for each point along the path. In particular, in FIG. 5, a typical user eating movement is depicted.

FIG. 6 shows a reference ideal path of an eating utensil. The movement of the eating utensil as determined in the Cartesian space at the points Psₙ as well as a relative speed and/or acceleration is compared with a reference or guide path. A reference path or golden guide is set to z-planes created around the eating utensil at every sample point along the path. The actual path of the eating utensil is then compared to the reference path. The instantaneous velocity V=(Vx)+(Vy)+(Vz) as well as the spoon points Ps₁ (x₁, y₁, z₁) at time t₁ are checked if they are inbound to the reference guide z-plane at t₁ with points Pg₁ (xₙ, yₙ, zₙ). The reference guide to which the movement of the eating utensil is to be compared is mapped to x, y, z axis.

According to an aspect of the invention, the smart eating utensil according to the invention is able to evaluate whether a user is eating properly or not. Furthermore, the smart eating utensil according to an aspect of the invention can teach the user, in particular a child, to improve its eating habits.

According to a further aspect of the invention, the smart eating utensil has a gamification processing which can integrate an animation game with the usage of the eating utensil. Accordingly, an interactive game for children can be achieved in order to improve the eating habits of the child.

Other variations of the disclosed embodiment can be understood and effected by those skilled in the art in practicing the claimed invention from a study of the drawings, the disclosure and the appended claims.

In the claims, the word “comprising” does not exclude other elements or steps and in the indefinite article “a” or “an” does not exclude a plurality.

A single unit or device may fulfil the functions of several items recited in the claims. The mere fact that certain measures are recited in mutual different dependent claims does not indicate that a combination of these measurements cannot be used to advantage. A computer program may be stored/distributed on a suitable medium such as an optical storage medium or a solid state medium, supplied together with or as a part of other hardware, but may also be distributed in other forms such as via the internet or other wired or wireless telecommunication systems.

Any reference signs in the claims should not be construed as limiting the scope.

1. A method of monitoring an eating utensil, wherein the eating utensil comprises a food area, a handle, an accelerometer sensor and a gyroscope sensor for detecting an orientation and path of the eating utensil and a wireless communication unit configured to wirelessly transmit the detected accelerometer and gyroscope data, said method comprising the steps of:
wirelessly receiving the detected accelerometer and gyroscope data by a smart device,
comparing the detected orientation and path of the eating utensil with a reference orientation and reference path, and
outputting a correction indication if the detected orientation and path of the eating utensil deviates from the reference orientation and reference path.

2. A method of monitoring an eating utensil according to claim 1, wherein the eating utensil further comprises a temperature sensor for detecting a temperature of food in the food area, and a weight sensor for detecting a weight of food in the food area, said method further comprising the step of receiving the temperature data and the weight data by the smart device.

3. A method of monitoring an eating utensil according to claim 2, further comprising the step of notifying a user if the temperature of food on the food area is too high or too cold or if the weight of the food portion is not as per reference guideline.

4. System of monitoring an eating utensil, comprising:
an eating utensil which has a food area and a handle, an accelerometer sensor and a gyroscope sensor and a wireless communication unit configured to wirelessly transmit the detected accelerometer and gyroscope data to a smart device, and
a smart device configured to wirelessly receive the transmitted accelerometer and gyroscope data from the eating utensil, to compare the detected orientation and path of the eating utensil with a reference orientation and path and to output a correction indication if the detected orientation and path of the eating utensil deviates from the reference orientation and reference path.

5. A computer program comprising program code means for causing a device to carry out the method of monitoring an eating utensil as defined in claim 1, when the computer program is run on the device.
